(19) United States
(12) Patent Application Publication
(10) Pub. No.: US 2026/0001383 A1
(43) Pub. Date: Jan. 1, 2026

(54) MOUNTING STRUCTURE OF ROOF DUCT FOR VEHICLE

(71) Applicants: Hyundai Motor Company, Seoul (KR); Kia Corporation, Seoul (KR); NVH KOREA, INC., Ulsan (KR)

(72) Inventors: Hong Keun SON, Hwaseong-si (KR); Won Jong LEE, Hwaseong-si (KR); Min Ho CHO, Hwaseong-si (KR); In Tae KIM, Hwaseong-si (KR)

(21) Appl. No.: 18/931,647

(22) Filed: Oct. 30, 2024

(30) Foreign Application Priority Data
Jun. 28, 2024 (KR) 10-2024-0085130

(51) Int. Cl. B60H 1/00; B60H 1/24

(52) U.S. Cl. CPC B60H 1/00564; B60H 1/245

(57) ABSTRACT

A mounting structure of a vehicle includes a roof duct arranged between a roof panel and a headlining of the vehicle and configured to guide air between regions of the vehicle, and an adhesive disposed at the roof duct and configured to fix the roof duct to the headlining. The adhesive is not applied to a deployment area of the headlining where a curtain airbag is deployed.

### CROSS-REFERENCE TO RELATED APPLICATION

This application claims, under 35 U.S.C. § 119(a), the benefit of and priority to Korean Patent Application No. 10-2024-0085130, filed on Jun. 28, 2024, the entire contents of which are incorporated herein by reference.

### TECHNICAL FIELD

The present disclosure relates to a mounting structure of a roof duct for a vehicle. More particularly, the present disclosure relates to a mounting structure of a roof duct for a vehicle, capable of securing the cross-sectional area of the roof duct in the vehicle that has adopted a panoramic sunroof.

### BACKGROUND

In a vehicle, when a vehicle window is opened to ventilate the cabin, exhaust fumes may come into the cabin, especially during high-speed travelling, and strong wind noise may enter the cabin even if the window is opened just a little, so it may not be easy to travel with the window open on a highway. In some cases, although the vehicle has a window, the interior of the vehicle may still be dark, and passengers may feel stuffy when the window is closed.

In some cases, a vehicle may include a sunroof mounted for providing ventilation, lighting, and a sense of openness. In some cases, the sunroof may be mounted to open and close a portion of a vehicle roof or the entire vehicle roof.

For example, the sunroof has an effect on ventilation during traveling, and when the sunroof is open in a tilt-up state, wind noise is reduced, much less or almost no exhaust fumes come in to the cabin, and the ventilation speed is increased.

Even in rainy situations, when the sunroof is open in a tilt-up state, it is good for ventilation and greatly reduces moisture build-up.

In some cases, panoramic sunroofs are used to maximize the sense of openness. For example, a panoramic sunroof may open a relatively large area and allow more direct sunlight to enter the cabin, which may generate heat.

In some cases, compared to a sunroof such as a dual sunroof, the panoramic sunroof may have an increased number of components, so the space for a duct to pass through is narrowed, and accordingly, the duct may extend to an area where a curtain airbag (CAB) mounted in the roof is deployed, causing interference, which may cause a delay in the deployment of the curtain airbag.

### SUMMARY

The present disclosure describes a mounting structure of a roof duct for a vehicle that has adopted a panoramic sunroof, where the roof duct is extended in the widthwise direction to secure the cross-sectional area thereof, and the mounting structure is capable of facilitating deployment of a curtain airbag when an impact occurs on the vehicle by not using an adhesive on an area in a headlining where the curtain airbag is deployed.

According to one aspect of the subject matter described in this application a mounting structure of a roof duct for a vehicle includes the roof duct arranged between a roof panel and a headlining and configured to move air, and an adhesive applied on the roof duct to fix the roof duct on the headlining, where the adhesive is not applied on a deployment area in the headlining where a curtain airbag is deployed.

In some implementations, the roof duct may include a shielding cover bonded to the roof duct using the adhesive applied on one side and another side thereof and configured to shield an open interior of the roof duct.

In some implementations, the adhesive may be applied on the shielding cover, excluding the deployment area.

In some implementations, the roof duct may include an extended portion extending from one side of the roof duct facing the deployment area, and a bending portion folded at the extended portion and bonded to another side of the roof duct by the adhesive.

In some implementations, the bending portion may include a bending guide member, having a notch shape at the extension portion and forming a folding point.

In some implementations, the adhesive may be applied on the bending portion, excluding the deployment area.

In some implementations, the roof duct may be blow-molded to have a closed cross-section.

In some implementations, the roof duct may be arranged between the roof panel and the headlining of the vehicle mounting thereto a panoramic sunroof.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed infra.

### BRIEF DESCRIPTION OF THE DRAWINGS

The above and other features of the present disclosure will now be described in detail with reference to certain exemplary implementations thereof illustrated in the accompanying drawings which are given herein below by way of illustration only, and thus are not limitative of the present disclosure.

FIG. 1 is a view illustrating a prior-art mounting structure of a roof duct for a vehicle that has adopted a panoramic sunroof.

FIG. 2 is a cross-sectional view taken along line A-A in FIG. 1 to show a prior-art mounting structure of a roof duct for a vehicle that has adopted a panoramic sunroof.

FIG. 3 is a view illustrating a prior-art mounting structure of a roof duct for a vehicle that has adopted a dual sunroof.

FIG. 4 is a cross-sectional view taken along line B-B in FIG. 3 to show a prior-art mounting structure of a roof duct for a vehicle that has adopted a dual sunroof.

FIG. 5 is a view illustrating an example of an adhesive applied on a mounting structure of a roof duct for a vehicle according the present disclosure.

FIG. 6 is a view illustrating an example of a mounting structure of a roof duct for a vehicle according the present disclosure.

FIG. 7A and FIG. 7B are views illustrating an example of a mounting structure of a roof duct for a vehicle according to the present disclosure.

FIG. 8 is a view illustrating an example of a mounting structure of a roof duct for a vehicle according the present disclosure.

In the figures, the reference numbers refer to the same or equivalent parts of the present disclosure throughout the several figures of the drawing.

### DETAILED DESCRIPTION

Hereinafter, one or more implementations according to the present disclosure will be described in detail with reference to the accompanying drawings.

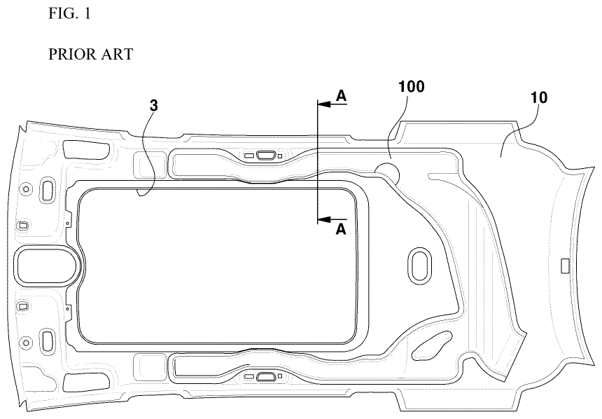

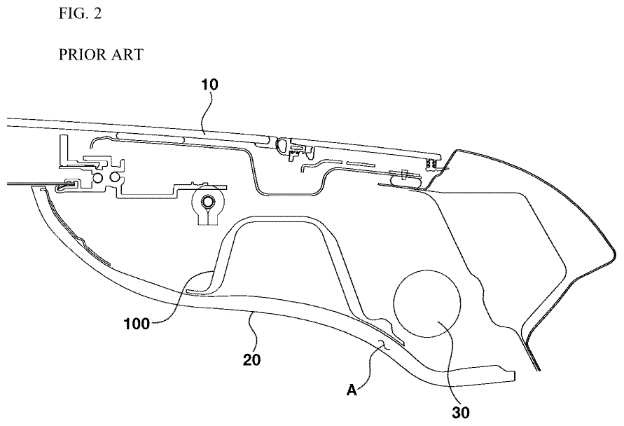

FIG. 1 is a view illustrating a prior-art mounting structure of a roof duct for a vehicle that has adopted a panoramic sunroof, and FIG. 2 is a cross-sectional view taken along line A-A in FIG. 1 to show a prior-art mounting structure of a roof duct for a vehicle that has adopted a panoramic sunroof.

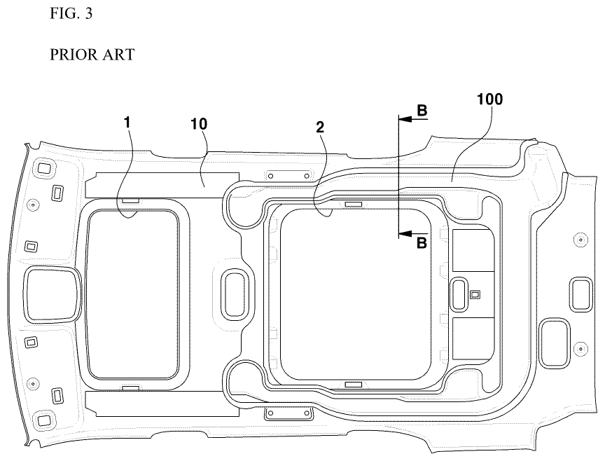

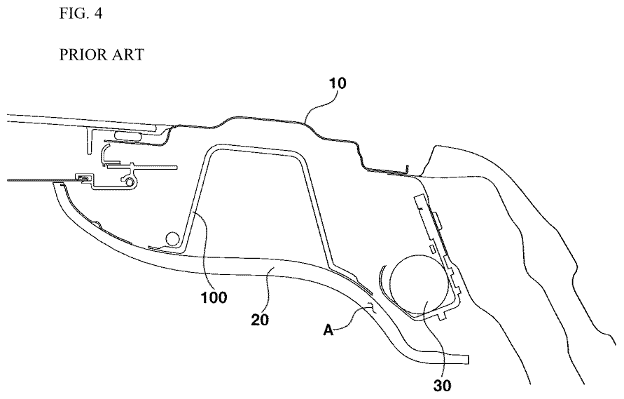

FIG. 3 is a view illustrating a prior-art mounting structure of a roof duct for a vehicle that has adopted a dual sunroof, and FIG. 4 is a cross-sectional view taken along line B-B in FIG. 3 to show a prior-art mounting structure of a roof duct for a vehicle that has adopted a dual sunroof.

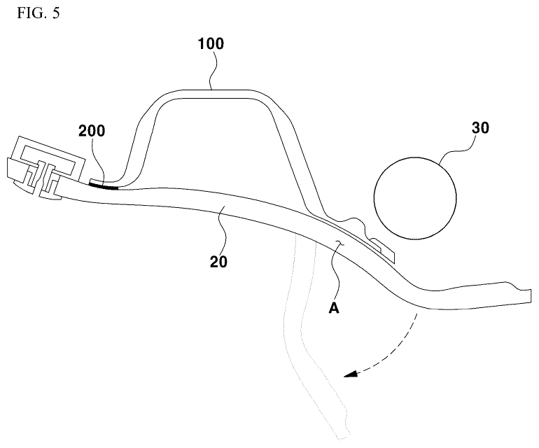

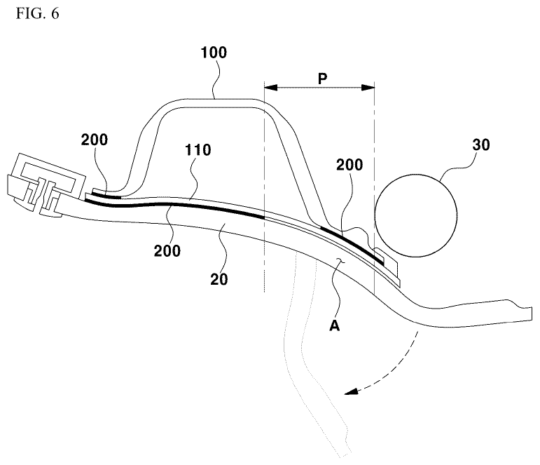

FIG. 5 is a view illustrating an example of an adhesive applied on a mounting structure of a roof duct for a vehicle according to the present disclosure, and FIG. 6 is a view illustrating an example of a mounting structure of a roof duct for a vehicle according to the present disclosure.

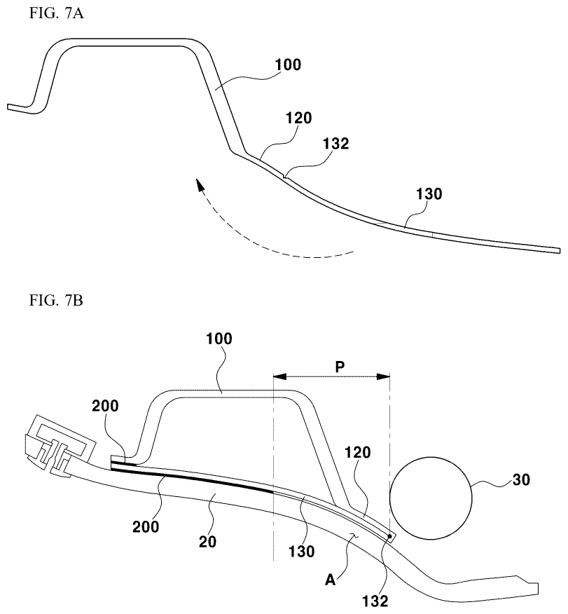

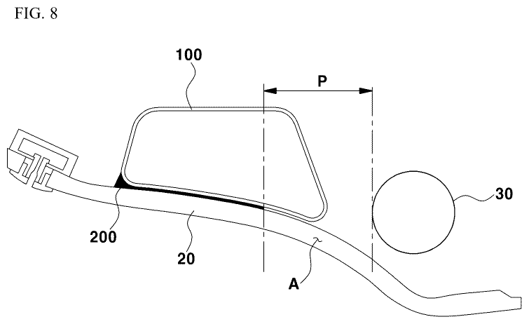

FIG. 7A and FIG. 7B are views illustrating another example of a mounting structure of a roof duct for a vehicle according to the present disclosure, and FIG. 8 is a view illustrating another example of a mounting structure of a roof duct for a vehicle according to the present disclosure.

As illustrated in FIG. 3 and FIG. 4, a vehicle has mounted there to a first sunroof 1 for front row seats and a second sunroof 2 for second and third row seats, and within a roof panel 10, more specifically, between the roof panel 10 and a headlining 20, provided is a roof duct 100.

The roof duct 100 is a passage to evenly supply cold or warm air generated from an air conditioner mounted in the vehicle to second and third row seats, as well as to first row seats. The roof duct 100 extends to surround the edge of the second sunroof 2 while bypassing the area where a curtain airbag 30 is deployed.

In some examples, the vehicle may include panoramic sunroofs for maximizing the openness of the vehicle interior. However, in the case of a panoramic sunroof 3 as illustrated in FIG. 1 and FIG. 2, because the area of the panoramic sunroof 3 increases, additional components, such as rails, increase, thereby increasing the number of components.

In the structure of the panoramic sunroof 3, as the number of additional components increases, the height-direction cross-section of the roof duct 100 is decreased, and accordingly, the width-direction cross-section of the roof duct 100 is increased to secure an area for passage (see FIG. 2).

When the width-direction cross-section of the roof duct 100 is increased, the roof duct 100 is arranged in the area where the curtain airbag 30 is deployed, i.e., in a deployment area A in the headlining 20, and such an arrangement may cause a problem of delaying deployment of the curtain airbag 30.

In other words, because the curtain airbag 30 is positioned in the deployment area A in the headlining 20, when an impact is applied to the vehicle, the curtain airbag 30 is inflated to open the deployment area A and is deployed into the interior of the vehicle.

In the structure of the panoramic sunroof 3, because the roof duct 100 positioned in the deployment area A has an increased width-direction cross-section, the curtain airbag 30 may open the deployment area A and be deployed into the interior of the vehicle only when the curtain airbag 30 is inflated beyond the adhesive force acting between the deployment area A and one side of the roof duct 100, thus decreasing the deployment speed of the curtain airbag 30.

To solve the problem of delaying deployment of the curtain airbag 30 described above, in this application, as illustrated in FIG. 5, an adhesive 200 is applied on the roof duct 100, excluding the deployment area A where the curtain airbag 30 is deployed, to fix the roof duct 100 on the headlining 20.

In other words, by applying the adhesive 200 only on either one side or another side of the roof duct 100, more specifically, by selectively applying the adhesive 200 only on the other side of the roof duct 100, not on the one side of the roof duct 100 facing the deployment area A, when the curtain airbag 30 is deployed due to an impact on the vehicle, etc., the deployment area A is separated from the one side of the roof duct 100 and the curtain airbag 30 is easily deployed while bending the headlining 20.

In some implementations, the roof duct 100 may be provided with, as illustrated in FIG. 6, a shielding cover 110 bonded to the roof duct 100 using the adhesive 200 applied on one side and another side of the shielding cover 110 and configured to shield the open interior of the roof duct 100.

For example, the shielding cover 110 is a structure to shield the open lower portion of the roof duct 100, and as described above, even though the deployment area A is separated from the one side of the roof duct 100 in the deployment of the curtain airbag 30, the shielding cover 110 may prevent leakage of air flowing through the roof duct 100.

In some implementations, the shielding cover 110 may be made of polyethylene terephthalate (PET) felt.

As such, when the roof duct 100 has a closed cross-section with the shielding cover 110, the adhesive 200 may be applied only on the other side of the shielding cover 110, excluding the deployment area A (see FIG. 6).

In other words, by applying the adhesive 200 only on either the one side or the other side of the shielding cover 110, more specifically, by selectively applying the adhesive 200 only on the other side of the shielding cover 110, not on the one side of the shielding cover 110 facing the deployment area A, when the curtain airbag 30 is deployed due to an impact on the vehicle, etc., the deployment area A is separated from the one side of the shielding cover 110 and the curtain airbag 30 is easily deployed while bending the headlining 20.

In some implementations, a section P where the adhesive 200 is not applied may have a predetermined length which allows the headlining 20 to be easily bent with respect to the other side of the shielding cover 110, on which the adhesive 200 is applied, when the curtain airbag 30 is deployed. For example, the length may be set to at least 30 mm from an innermost side of the curtain airbag 30.

In some examples, the roof duct 100 may be, as illustrated in FIG. 8, blow-molded to have a closed cross-section to prevent air leakage. In this structure, the adhesive 200 may selectively applied only on the other side of the roof duct 100, not on the one side of the roof duct 100 facing the deployment area A.

In some examples, a section P where the adhesive 200 is not applied may have, as same as the above, a predetermined length which allows the headlining 20 to be easily bent with respect to the other side of the roof duct 100, on which the adhesive 200 is applied, when the curtain airbag 30 is deployed. For example, the length may be set to at least 30 mm from an innermost side of the curtain airbag 30.

In some examples, an upper side of the shielding cover 110 faces the roof duct 100, and a lower side of the shielding cover 110 faces the headlining 20, where the shielding cover 110 has (i) a first section (e.g., section P) disposed adjacent to the deployment area and (ii) a second section spaced apart from the deployment area, for example, the rest of the shielding cover other than section P. The adhesive 200 may not be applied to the lower side of the first section of the shielding cover, and the adhesive 200 may be applied to both of the upper side and the lower side of the second section of the shielding cover 110. The adhesive may be applied to the upper side of the first section of the shielding cover 110. In some examples, a length of the adhesive 200 applied to the upper side of the first section of the shielding cover 110 may be less than a length of the adhesive 200 applied to the lower side of the second section of the shielding cover 110.

In some implementations, the roof duct 100 may include, as illustrated in FIG. 7A, an extended portion 120 and a bending portion 130.

In some examples, the extended portion 120 may be integrated with the one side of the roof duct 100 facing the deployment area A.

Moreover, the bending portion 130 may be folded at the extended portion 120 and is adhered to the other side of the roof duct 100 by the adhesive 200.

The bending portion 130 may include a bending guide member 132, having a notch shape at the extended portion 120 and forming a folding point.

More specifically, the bending guide member 132 is a structure to facilitate folding of the bending portion 130 at the extended portion 120 by having a notch shape. As illustrated in FIG. 7B, when the bending portion 130 is folded from the extended portion 120, the open lower portion of the roof duct 100 is shielded so that the roof duct 100 forms a closed cross-section to prevent air leakage.

As such, in the state in which the roof duct 100 forms a closed cross-section, the adhesive 200 is selectively applied only on either one side or another side of the bending portion 130, more specifically, applied only on the other side of the bending portion 130, not on the one side of the bending portion 130 facing the deployment area A, and thus, when the curtain airbag 30 is deployed due to an impact on the vehicle, etc., the deployment area A is separated from the one side of the bending portion 130 and the curtain airbag 30 is easily deployed while bending the headlining 20.

In some implementations, a section P (first section) where the adhesive 200 is not applied may have a predetermined length which allows the headlining 20 to be easily bent with respect to the other side of the bending portion 130, on which the adhesive 200 is applied, when the curtain airbag 30 is deployed. In some examples, the length may be set to at least 30 mm from an innermost side of the curtain airbag 30.

As is apparent from the above description, the present disclosure provides the following effects.

According to the present disclosure, a vehicle that has adopted a panoramic sunroof has a roof duct extended in the widthwise direction to secure the cross-sectional area thereof, and deployment of a curtain airbag when an impact occurs on the vehicle may be facilitated by not using an adhesive on an area in a headlining where the curtain airbag is deployed.

Moreover, according to the present disclosure, a problem of delaying deployment of the curtain airbag caused by the roof duct being a hindrance in opening the headlining may be prevented, improving customer satisfaction.

In the above, implementations of the present disclosure have been described with reference to the accompanying drawings. However, those skilled in the art to which the present disclosure pertains will understand that various modifications may be made therefrom, and that all or part of the above-described implementations may be selectively combined. Therefore, the true technical protection scope of the present disclosure should be determined by the technical ideas of the appended claims.

What is claimed is:

1. A mounting structure of a vehicle, comprising:
a roof duct arranged between a roof panel and a headlining of the vehicle and configured to guide air between regions of the vehicle, wherein the headlining includes a deployment area from which a curtain airbag is deployed; and
an adhesive disposed at the roof duct and configured to fix the roof duct to the headlining, wherein the adhesive is not disposed at the deployment area of the headlining.

2. The mounting structure according to claim 1, wherein the roof duct has an open interior, and
wherein the roof duct comprises a shielding cover that covers the open interior of the roof duct and is attached to the roof duct and the headlining using the adhesive that is applied to an upper side and a lower side of the shielding cover.

3. The mounting structure according to claim 2, wherein the adhesive is applied to the shielding cover excluding the deployment area.

4. The mounting structure according to claim 2, wherein the upper side of the shielding cover faces the roof duct, and the lower side of the shielding cover faces the headlining,
wherein the shielding cover has (i) a first section disposed adjacent to the deployment area and (ii) a second section spaced apart from the deployment area,
wherein the adhesive is not applied to the lower side of the first section of the shielding cover, and
wherein the adhesive is applied to both of the upper side and the lower side of the second section of the shielding cover.

5. The mounting structure according to claim 4, wherein the adhesive is applied to the upper side of the first section of the shielding cover.

6. The mounting structure according to claim 5, wherein a length of the adhesive applied to the upper side of the first section of the shielding cover is less than a length of the adhesive applied to the lower side of the second section of the shielding cover.

7. The mounting structure according to claim 1, wherein the roof duct comprises:
an extended portion that extends from a first side of the roof duct, the first side facing the deployment area; and
a bending portion that is folded from a position of the extended portion and attached to a second side of the roof duct by the adhesive.

8. The mounting structure according to claim 7, wherein the bending portion comprises a bending guide member having a notch shape defined at the extension portion, the bending guide member defining a folding point of the roof duct.

9. The mounting structure according to claim 7, wherein the adhesive is applied to the bending portion excluding the deployment area.

10. The mounting structure according to claim 1, wherein the roof duct is blow-molded and has a closed cross-section.

11. The mounting structure according to claim 1, wherein the vehicle includes a panoramic sunroof disposed at the roof panel, and
wherein the roof duct is arranged around the panoramic sunroof of the vehicle.

12. A vehicle comprising:
a roof panel;
a headlining that is disposed at the roof panel and defines an interior of the vehicle, the headlining including a deployment area from which a curtain airbag is deployed;
a roof duct arranged between the roof panel and the headlining and configured to guide air between regions of the vehicle; and
an adhesive that is disposed at the roof duct and fixes the roof duct to the headlining, wherein the adhesive is not disposed at the deployment area of the headlining.

13. The vehicle according to claim 12, wherein the vehicle includes a panoramic sunroof disposed at the roof panel, and
wherein the roof duct is arranged around the panoramic sunroof.

14. The vehicle according to claim 12, wherein the roof duct has an open interior, and
wherein the roof duct comprises a shielding cover that covers the open interior of the roof duct and is attached to the roof duct and the headlining using the adhesive that is applied to an upper side and a lower side of the shielding cover.

15. The vehicle according to claim 14, wherein the adhesive is applied to the shielding cover excluding the deployment area.

16. The vehicle according to claim 14, wherein the upper side of the shielding cover faces the roof duct, and the lower side of the shielding cover faces the headlining,
wherein the shielding cover has (i) a first section disposed adjacent to the deployment area and (ii) a second section spaced apart from the deployment area,
wherein the adhesive is not applied to the lower side of the first section of the shielding cover, and
wherein the adhesive is applied to both of the upper side and the lower side of the second section of the shielding cover.

17. The vehicle according to claim 16, wherein the adhesive is applied to the upper side of the first section of the shielding cover.

18. The vehicle according to claim 17, wherein a length of the adhesive applied to the upper side of the first section of the shielding cover is less than a length of the adhesive applied to the lower side of the second section of the shielding cover.
